(19) United States
(12) Patent Application Publication
(10) Pub. No.: US 2008/0316159 A1
(43) Pub. Date: Dec. 25, 2008

(54) Liquid crystal display device with scanning controlling circuit and driving method thereof

(75) Inventor: Xiao-Jing Qi, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/214,937

(22) Filed: Jun. 23, 2008

(30) Foreign Application Priority Data
Jun. 22, 2007 (CN) 200710076202.4

(51) Int. Cl. G09G 3/36

(52) U.S. Cl. 345/92; 345/87

(57) ABSTRACT

A liquid crystal display (LCD) device includes a liquid crystal panel, a gate driver, gate lines, a data driver, and a scanning controlling circuit. The gate driver is configured for providing scanning signals to the gate lines. The scanning controlling circuit is connected between the gate driver and the gate lines and controls the gate driver to scan the odd-row gate lines in a first half-frame time, and scan the even-row gate lines in a second half-frame time.

### FIELD OF THE INVENTION

Embodiments of the present disclosure relate to liquid crystal display (LCD) devices and driving methods thereof, and particularly to a system and method for driving an LCD device with a scanning controlling circuit.

### GENERAL BACKGROUND

Because LCD devices have the advantages of portability, low power consumption, and low radiation, they have been widely used in various portable information products such as notebooks, personal digital assistants (PDAs), video cameras, and the like.

Referring to FIG. 2, a typical liquid crystal display device 10 includes a gate driver 13, a data driver 11 and a liquid crystal panel 15. The liquid crystal panel 15 includes a plurality of gate lines 151 (including G1, G2, . . . , G2n), a plurality of data lines 153, and a plurality of pixels 150.

The data driver 11 provides data signals to the pixels 150 via the data lines 153 when the TFTs 155 are turned on. The gate driver 13 provides scanning voltages to the gate lines 151 to switch the TFTs 155 on and off. Each output terminal (not shown) of the gate driver 13 can drive only one of the gate lines 151. As a size of the LCD device 10 increases, then more of the gate drivers 13 are required, thus increasing an expenditure of the LCD device 10.

What is needed, therefore, is an LCD device that can overcome the above-described deficiencies.

### SUMMARY

In an exemplary embodiment, a liquid crystal display (LCD) device includes a liquid crystal panel, a gate driver, gate lines, a data driver, and a scanning controlling circuit. The gate driver is configured for providing scanning signals to the gate lines. The scanning controlling circuit is connected between the gate driver and the gate lines and controls the gate driver to scan the odd-row gate lines in a first half-frame time, and scan the even-row gate lines in a second half-frame time.

Other novel features and advantages of the present LCD device will become more apparent from the following detailed description when taken in conjunction with the accompanying drawings. In the drawings, all the views are schematic.

### BRIEF DESCRIPTION OF THE DRAWINGS

FIG. 1 is an abbreviated circuit diagram of one embodiment of an LCD device of the present disclosure.

FIG. 2 is an abbreviated circuit diagram of a conventional LCD device.

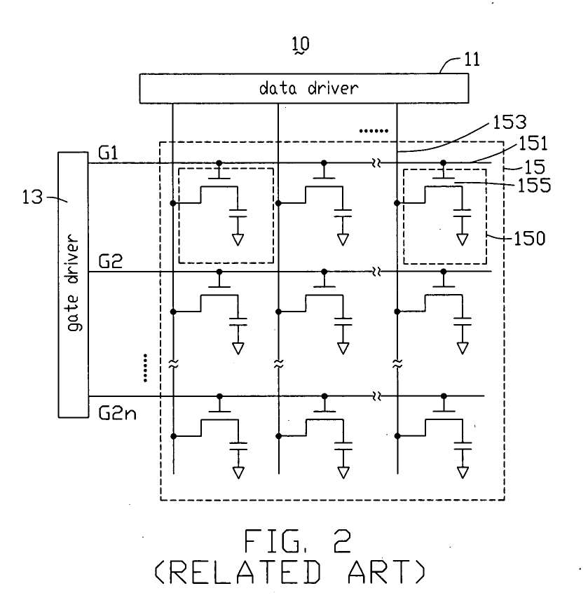

### DETAILED DESCRIPTION OF CERTAIN INVENTIVE EMBODIMENTS

Reference will now be made to the drawing figures to describe various inventive embodiments of the present disclosure in detail.

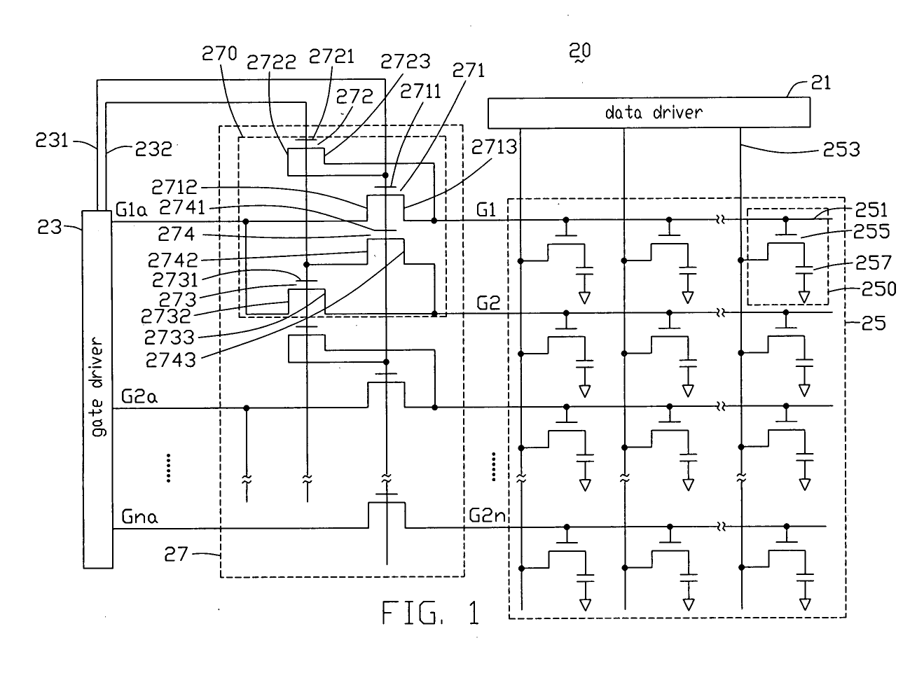

Referring to FIG. 1, an LCD device 20 includes a gate driver 23, a data driver 21, a liquid crystal panel 25, and a scanning controlling circuit 27. The liquid crystal panel 25 includes a plurality of gate lines 251 (including G1, G2, . . . , G2n), a plurality of data lines 253, and plurality of pixels 250. In one embodiment, the plurality of gate lines 251 may be substantially parallel to one another, and the plurality of data lines 253 may also be substantially parallel to one another. An intersection of an area between two of the plurality of gate lines 251 and an area between two of the plurality of data lines 253 may define a minimum area for each of the plurality of pixels 250.

Each of the pixels 250 comprises a thin film transistor (TFT) 255 disposed in a vicinity between an two of the intersecting gate lines 251 and data lines 253. Furthermore, each of the pixels 250 comprises a liquid crystal capacitor 257. A source electrode of the TFT 255 is connected to the data line 253, a gate electrode of the TFT 255 is connected to the gate line 251, and a drain electrode of the TFT 255 is connected to one electrode of the liquid crystal capacitor 257.

The gate driver 23 includes a plurality of scanning voltage output terminals G1a, G2a, . . . , Gn-1a, Gna, an odd-row scanning controlling terminal 231, and an even-row scanning controlling terminal 232. The gate driver 23 provides scanning voltages to the gate lines 251 to control switching of the TFTs 255 via the scanning controlling circuit 27. The data driver 21 provides data signals to the pixels 250 via the data lines 253 when the TFTs 255 are turned on. The data signals are interlace signals in that order D1, D3, . . . , D2n-1, D2, D4, D2n.

The scanning controlling circuit 27 includes a plurality of scanning controlling units 270. Each of the scanning controlling units 270 includes a first TFT 271, a second TFT 272, a third TFT 273, and a fourth TFT 274.

A source electrode 2712 of the first TFT 271 is connected to the scanning voltage output terminal G1a of the gate driver 23, a drain electrode 2713 of the first TFT 271 is connected to the gate line G1, and a gate electrode 2711 of the first TFT 271 is connected to the odd-row scanning controlling terminal 231.

A source electrode 2722 of the second TFT 272 is connected to the odd-row scanning controlling terminal 231, a drain electrode 2723 of the second TFT 272 is connected to the gate line G1, and a gate electrode 2721 of the second TFT 272 is connected to the even-row scanning controlling terminal 232.

A source electrode 2732 of the third TFT 273 is connected to the scanning voltage output terminals G1a of the gate driver 23, a drain electrode 2733 of the third TFT 273 is connected to the gate line G2, and a gate electrode 2731 of the third TFT 273 is connected to the even-row scanning controlling terminal 232.

A source electrode 2742 of the fourth TFT 274 is connected to the even-row scanning controlling terminal 232, a drain electrode 2743 of the fourth TFT 274 is connected to the gate line G2, and a gate electrode 2741 of the fourth TFT 274 is connected to the odd-row scanning controlling terminal 231.

The odd-row scanning controlling terminal 231 may provide a high voltage (e.g. 20 V (volts)), and the even-row scanning controlling terminal 232 may provide a low voltage (e.g. −10 V) to the scanning control circuit 27. In one particular embodiment, the high and low voltages provided by the odd-row scanning terminal 231 and the even-row scanning terminal 232, respectively, may turn on the first TFT 271 and the fourth TFT 274 and turn off the second TFT 272 and the third TFT 273 of the scanning control circuit 27. Because the fourth TFT 274 is turned on, the low voltage provided by the even-row scanning controlling terminal 232 is supplied to the gate line G2 via the fourth TFT 274 to turn off all the TFTs 255 connected to the gate line G2. Thus, when the scanning voltage output terminal G1a outputs a scanning voltage, the scanning voltage is supplied to the gate line G1, via the first TFT 271, to turn on all the TFTs 255 connected to the gate line G1. However, the gate line G2 is not scanned.

The odd-row scanning controlling terminal 231 may provide a low voltage (e.g. −10 V), and the even-row scanning controlling terminal 232 may provide a high voltage (e.g. 20 V) to the scanning control circuit 27. In one particular embodiment, the low and high voltages provided by the odd-row scanning control terminal 231 and the even-row scanning controlling terminal, respectively, may turn on the second TFT 272 and the third TFT 273, and turn off the first TFT 271 and the fourth TFT 274. Because the second TFT 272 is turned on, the low voltage provided by the odd-row scanning controlling terminal 231 is supplied to the gate line G1 via the second TFT 272 to turn off all the TFTs 255 connected to the gate line G1. Thus, when the scanning voltage output terminal G1a of the gate driver 23 outputs a scanning voltage, the scanning voltage is supplied to the gate line G2 via the third TFT 273 to turn on all the TFTs 255 connected to the gate line G2. However, the gate line G1 is not scanned. Hence, the gate lines G1 and G2 are selected to be scanned respectively in a first half-frame time and a successive second half-frame time of one frame time by the scanning controlling unit 270. That is, one scanning voltage output terminal G1a corresponds to and controls two gate lines G1 and G2 when applying the scanning controlling unit 270.

It may be understood that a similar principle may be applied to other scanning lines of the gate driver 23. For example, the scanning voltage output terminal G2a may correspond to two of the gate lines G3 and G4 such that the gate lines G3 and G4 may be scanned via another scanning controlling unit such as the scanning control circuit 270. In another example, a similar principle may be applied to a gate driver with “n” number of scanning controlling lines. In one particular example, the scanning voltage output terminal Gna may correspond to two gate lines G2n-1 and G2n. Therefore, only n number of scanning voltage output terminals G1a, G2a, . . . , Gn-1a, Gna are needed to control the scanning of 2n gate lines G1 G2, . . . , G2n-1, G2n by employing the scanning controlling circuit 27. During the first half-frame time, the odd-row gate lines G1, G3, . . . , G2n-1 are scanned, and data signals are applied to corresponding pixels 250 sequentially. During the second half-frame time, the even-row gate lines G2, G4, . . . , G2n are scanned, and data signals are applied to corresponding pixels 250 sequentially.

A method of driving the LCD device 20 is described in detail as follows. During the a half-frame time, the odd-row scanning controlling terminal 231 outputs a high voltage Vgh, which can be 15 V or 20 V, for example, and the even-row scanning controlling terminal 232 outputs a low voltage Vgl, which can be −10 V, for example. In this example, the first and fourth TFTs 271, 274 of each scanning controlling unit 270 are turned on, and the second and third TFTs 272, 273 of each scanning controlling unit 270 are turned off. Thus, the low voltage Vgl is applied to the even-row gate lines G2, G4, . . . , G2n-2, G2n to make all the TFTs 255 connected thereto turned off during the first half-frame time.

In one embodiment, the scanning voltage output terminals G1a, G2a, . . . , Gn-1a, Gna of the gate driver 23 may output scanning voltages in a sequential manner. The outputted scanning voltages may then be applied in a sequential manner to the odd-row gate lines G1, G3, . . . , G2n-1 via the first TFT 271 of each scanning controlling unit 270 to turn on all the TFTs 255 connected to each of the corresponding gate lines 251. The data driver 21 provides interlace data signals, D1, D3, . . . , D2n-1, in a sequential manner, to the corresponding odd-row pixels 250. For example, when the gate line G1 is scanned, the data driver 21 provides the data signal D1 to the pixels 250 connected to the gate line G1. When the gate line G3 is scanned, the data driver 21 provides data signal D3 to the pixels 250 connected to the gate line G3. When the gate line G2n-1 is scanned, the data driver 21 provides data signal D2n-1 to the pixels 250 connected to the gate line G2n-1.

During a second half-frame time, the odd-row scanning controlling terminal 231 outputs the low voltage Vgl, and the even-row scanning controlling terminal 232 outputs the high voltage Vgh. In this example, the first and fourth TFTs 271, 274 of each scanning controlling unit 270 are turned off, and the second and third TFTs 272, 273 of each scanning controlling unit 270 are turned on. Thus, the low voltage Vgl is applied to the odd-row gate lines G1, G3, . . . , G2n-1 to turn off all the TFTs 255 connected thereto during the second half-frame time.

Accordingly, during the second half-frame time, the scanning voltages are applied to the even-row gate lines G2, G4, . . . , G2n via the third TFT 273 to turn on all the TFTs 255 connected to each of the corresponding gate lines 251. The data driver 21 provides interlace data signals D2, D4, . . . , D2n in a sequential manner to the corresponding even-row pixels 250. For example, when the gate line G2 is scanned, the data driver 21 provides the data signal D2 to the pixels 250 connected to the gate line G2. When the gate line G4 is scanned, the data driver 21 provides the data signal D4 to the pixels 250 connected to the gate line G4. When the gate line G2n is scanned, the data driver 21 provides the data signal D2n to the pixels 250 connected to the gate line G2n, and so on. During a next frame time, operations are repeated according to a similar principle.

As described above, the LCD device 20 operates in an interlaced scanning method to display frame images. Each one of the scanning voltage output terminals G1a, G2a, . . . , Gn-1a, Gna can drive two gate lines 251 by employing the scanning controlling circuit 27. Thus, the number of gate drivers 21 required for the LCD 20 decreases by half. Accordingly, a cost to manufacture the LCD device 20 decreases as well.

It is to be understood, however, that even though numerous characteristics and advantages of certain inventive embodiments of the present disclosure have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display (LCD) device, comprising:
a liquid crystal panel comprising a plurality of gate lines; and
a gate driver configured for providing scanning signals to the gate lines, wherein the gate driver has an odd-row gate line and an even-row gate line; and
a scanning controlling circuit connected between the gate driver and the plurality of gate lines, the scanning controlling circuit configured for controlling the gate driver to scan the odd-row gate line in a first half-frame time, and scan the even-row gate line in a successive second half-frame time.

2. The LCD device of claim 1, wherein the gate driver comprises a plurality of scanning signal output terminals, an odd-row scanning controlling terminal, and an even-row scanning controlling terminal, wherein the scanning signal output terminals are configured for providing scanning signals to the gate lines via the scanning controlling circuit, wherein the odd-row scanning controlling terminal and the even-row scanning controlling terminal control the scanning controlling circuit in order to select one of the even-row gate line and one of the odd-row gate line being scanned.

3. The LCD device of claim 2, wherein the odd-row scanning controlling terminal outputs a high voltage and the even-row scanning controlling terminal outputs a low voltage, in order to select the odd-row gate lines being scanned.

4. The LCD device of claim 2, wherein the odd-row scanning controlling terminal outputs a low voltage and the even-row scanning controlling terminal outputs a high voltage, in order to select the even-row gate line being scanned.

5. The LCD device of claim 2, wherein the scanning controlling circuit comprises a plurality of scanning controlling units, each scanning controlling unit comprises a first, a second, a third, and a fourth thin film transistor (TFTs), wherein a source electrode of the first and the third TFTs is connected to a same scanning signal output terminal, wherein a drain electrode of the first and the third TFTs is connected to two adjacent gate lines respectively, a drain electrode of the second TFT being connected to the drain electrode of the first TFT, a drain electrode of the fourth TFT being connected to the drain electrode of the third TFT, a gate electrode of the first and the fourth TFTs and a source electrode of the second TFT being connected to the odd-row scanning controlling terminal, and a gate electrode of the second and the third TFTs and a source electrode of the fourth TFT being connected to the even-row scanning controlling terminal.

6. The LCD device of claim 5, wherein the drain electrode of the first TFT is connected to the odd-row gate line, and the drain electrode of the third TFT is connected to the even-row gate line.

7. The LCD device of claim 6, wherein a frame time comprises the first half-frame time and the successive second half-frame time, wherein the first and the fourth TFTs are turned on during the first half-frame time, and wherein the second and the third TFTs are turned off during the first half-frame time.

8. The LCD device of claim 7, wherein the even-row scanning controlling terminal provides a low voltage to the even-row gate line via the fourth TFT to turn off the TFTs connected thereto.

9. The LCD device of claim 8, wherein the first and the fourth TFTs are turned off, and the second and the third TFTs are turned on during the successive second half-frame time.

10. The LCD device of claim 9, wherein the odd-row scanning controlling terminal provides a low voltage to the odd-row gate line via the first TFT to turn off the TFTs connected thereto.

11. The LCD device of claim 3, wherein the low voltage is -10 volts, and the high voltage is a selected one of 15 volts or 20 volts.

12. A method for driving an LCD device, wherein the LCD device comprises a gate driver and a scanning controlling circuit comprising thin-film transistors (TFTs), wherein the TFTs are arranged such that a first and a fourth TFT are connected via an odd-row gate line of the gate driver and a second and a third TFT are connected via an even-row gate line of the gate driver, and wherein a scanning voltage signal can be sent from the gate driver to drive the LCD, the method comprising:
outputting the scanning voltage signal, via the odd-row gate line, during a first half-frame time of the LCD device, to the scanning-controlling circuit in order to sequentially turn on the first and the fourth TFTs; and
outputting the scanning voltage signal, via the even-row gate line, during a successive second half-frame time of the LCD device, to the scanning controlling circuit in order to sequentially turn on the second and the third TFTs.

13. The method of claim 12, further comprising applying a low voltage to the even-row gate line to turn off the second TFT and the third TFT connected thereto, and outputting, via the gate driver, the scanning voltage signal to the odd-row gate line via the first TFT.

14. The method of claim 13, wherein the gate driver comprises an odd-row scanning terminal connected to the odd-row gate line and an even-row scanning terminal connected to the even-row gate line, and the method further comprises outputting a low voltage signal by the odd-row scanning terminal and outputting a high voltage by the even-row scanning terminal to turn off the first and the fourth TFTs and turn on the second and the third TFTs.

15. The method of claim 14, further comprising applying a low voltage to the odd-row gate line in order to turn off the first TFT and the fourth TFT connected thereto, and outputting the scanning voltage signal, via the gate driver, to the even-row gate line via the third TFT.

16. The method of claim 12, wherein data signals provided to the LCD device are interlaced data signals.
